(19) United States
(12) Patent Application Publication
(10) Pub. No.: US 2008/0256217 A1
(43) Pub. Date: Oct. 16, 2008

(54) MOBILE COMMUNICATION DEVICE HAVING WEB ALARM FUNCTION AND OPERATING METHOD OF THE MOBILE COMMUNICATION DEVICE

(75) Inventors: Yeon Woo PARK, Seoul (KR); Sang Yeon Lim, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/016,831

(22) Filed: Jan. 18, 2008

(30) Foreign Application Priority Data
Apr. 11, 2007 (KR) 10-2007-0035620

(51) Int. Cl. G06F 3/048; G06F 15/16

(52) U.S. Cl. 709/218; 715/810

(57) ABSTRACT

A method of operating a mobile communication device. The method includes receiving a website address, receiving an alarm time, accessing a website corresponding to the website address upon arrival of the alarm time, and outputting an alarm signal in combination with accessing the website.

This application claims priority to Korean Patent Application No. 10-2007-0035620 filed on Apr. 11, 2007 in Korea, the entire contents of which is herein incorporated by reference in its entirety.

### BACKGROUND OF THE INVENTION

1. Field of the Invention

The present invention relates to a mobile communication device and corresponding method in which a web site is automatically displayed at a set alarm time.

2. Description of the Related Art

Mobile communication devices such as mobile phones or personal digital assistants (PDAs) provide not only basic functions such as voice call and Short Message Service (SMS) functions, but also various additional functions. Further, a user of the mobile communication device can also access the Internet.

Therefore, the user can view several different websites provided on the Internet. For example, the user can access a website corresponding to his or her work emails, and therefore review the work emails when first waking up in the morning. That is, the user first accesses the website that includes their work emails (or personal emails) by entering the appropriate website address.

The user then enters his or her login identification and password. The user can then review their different emails. The user can also access an Internet website such as “www.cnn.com” to view the daily news. However, to view a particular website, the user must manually input the website address, logon information, etc. each time the user accesses the website. This is often time consuming and cumbersome, because the size of the display on a mobile communication terminal is small.

### SUMMARY OF THE INVENTION

Accordingly, one object of the present invention is to address the above-noted and other problems.

Another object of the present invention is to provide a mobile communication device and corresponding method in which a user can set an alarm time and have a desired website be accessed at the set alarm time.

To achieve these and other advantages and in accordance with the purpose of the present invention, as embodied and broadly described herein, the present invention provides in one aspect a method of operating a mobile communication device. The method includes receiving a website address, receiving an alarm time, accessing a website corresponding to the website address upon arrival of the alarm time, and outputting an alarm signal in combination with accessing the website.

In another aspect, the present invention provides A mobile communication device including a wireless communication device configured to access the Internet, a display unit configured to display a menu including fields allowing a user of the mobile communication device to input a website address and an alarm time, and a control unit configured to receive the input website address and the alarm time, to access a website corresponding to the website address via the wireless communication device upon arrival of the alarm time, and to output an alarm signal in combination with accessing the website.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram illustrating a mobile communication device according to an embodiment of the present invention;

FIG. 2 is a flowchart illustrating a method of setting of a web alarm according to an embodiment of the present invention;

FIG. 3 is a flowchart illustrating a method of displaying a webpage of a corresponding website upon arrival of a designated alarm time according to an embodiment of the present invention;

FIG. 4 is a flowchart illustrating a method of displaying a webpage of a corresponding website upon arrival of a designated alarm time according to another embodiment of the present invention;

FIG. 5 is an overview of a web alarm setting menu screen displayed on a mobile device according to an embodiment of the present invention;

FIG. 6 is an overview of a web alarm setting menu screen displayed on a mobile device according to another embodiment of the present invention;

FIG. 7 is an overview illustrating a screen displayed by a display unit upon the arrival of a designated alarm time according to an embodiment of the present invention; and

FIG. 8 is an overview illustrating a screen displayed by a display unit upon the arrival of a designated alarm time according to another embodiment of the present invention.

### DETAILED DESCRIPTION OF THE INVENTION

The present invention will hereinafter be described in detail with reference to the accompanying drawings in which the different embodiments of the invention are shown.

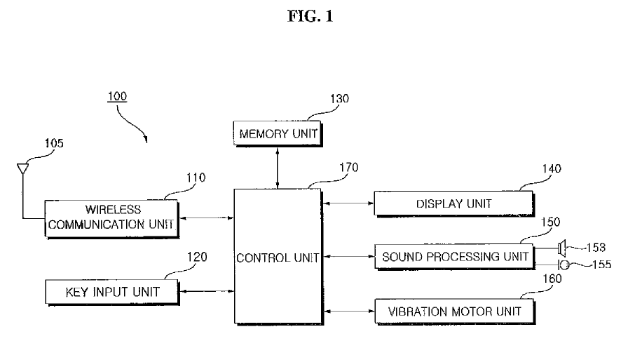

Turning first to FIG. 1, which is a block diagram illustrating a mobile communication device 100 according to an embodiment of the present invention. Referring to FIG. 1, the mobile communication device 100 includes a wireless communication unit 110, a key input unit 120, a memory unit 130, a display unit 140, a sound processing unit 150, a vibration motor unit 160 and a control unit 170.

The wireless communication unit 110 provides an interface for wireless communication with a base station through an antenna 105. Further, the wireless communication unit 110 may include a duplex filter for filtering a signal received through the antenna 105, a power amplifier for amplifying a transmit signal, a frequency up-converting circuit in a transmission path, and a frequency down-converting circuit in a reception path. The wireless communication unit 110 also provides an interface for accessing a wireless Internet and enables a user to access any desired website via the Internet.

Further, the key input unit 120 includes a plurality of keys, e.g., a plurality of number keys and function keys, and a keypad. The key input unit 120 transmits a signal corresponding to a key pressed by the user to the control unit 170 so that the user can input an operation command and data into the mobile communication device 100.

In addition, the memory unit 130 stores data used for controlling the mobile device 100 and other various data that the user wants to store in the memory unit 130. The memory unit 130 also stores information such as an alarm time designated by the user and a website address previously registered to correspond with the set web alarm. The memory unit 130 may also store login authentication information such as a user identifier and a password that are used to log onto a predetermined website.

Also, the display unit 140 may include a display window formed with a liquid crystal display (LCD). The display unit 140 also displays menus used for controlling an operation of the mobile communication device 100, a state of a received call, battery information, and an operating state of the mobile communication device 100 that varies in response to a user command. Further, the display unit 140 displays a web alarm setting menu under the control of the control unit 170. That is, the web alarm function is a function for accessing a predetermined website at an alarm time previously designated by the user and then outputting an alarm signal to the user.

The sound processing unit 150 amplifies a sound signal output by the control unit 170 and outputs the amplified sound signal to a speaker 153. Also, the sound processing unit 150 converts a sound signal input via a microphone 155 into an electrical signal and transmits the electrical signal to the control unit 170. In addition, the sound processing unit 150 outputs an alarm sound via the speaker 153 under the control of the control unit 170 upon the arrival of an alarm time.

Further, when the mobile communication device 100 is set to a vibration mode, the vibration motor unit 160 vibrates under the control of the control unit 170, for example, upon receipt of an incoming call. Also, the vibration motor unit 160 generates a vibration signal under the control of the control unit 170 upon the arrival of an alarm time so that the user is notified of the arrival of the alarm time. The alarm signal may also be a particular alarm sound, may be lights flashing on an off on the mobile device, the vibration of the mobile device, a personal voice message, a music file, etc., and any combination thereof.

In addition, the control unit 170 controls the overall operations of the mobile communication device 100 by controlling the wireless communication unit 110, the key input unit 120, the memory unit 130, the display unit 140, the sound processing unit 150 and the motor vibration unit 160. More specifically, when a web alarm function is set, the control unit 170 sets an alarm time using a timer (not shown) included therein and controls the mobile communication device 100 to access a predetermined website upon the arrival of the alarm time and then output an alarm signal.

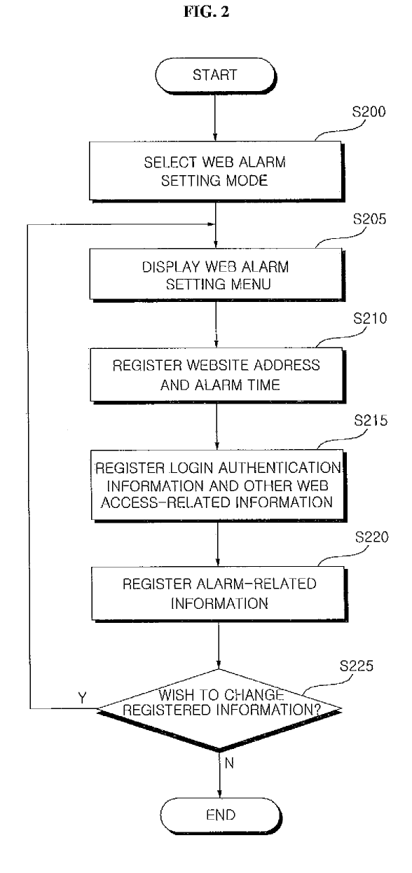

Turning next to FIG. 2, which is a flowchart illustrating a method of setting of a web alarm according to an embodiment of the present invention. FIG. 1 will also be referred to throughout the description of the embodiments of the present invention. As shown in FIG. 2, a user first selects a web alarm setting mode using the key input unit 120 to thereby set a web alarm function (S200). The control unit 170 then controls the display unit 140 to display a web alarm setting menu for setting the web alarm function (S205). As discussed above, the web alarm function is a function for accessing a designated website upon the arrival of an alarm time designated by a user and then outputting an alarm signal.

Next, an alarm time and a website address are registered under control of the control unit 170 via the web alarm setting menu (S210). Further when a website corresponding to the received website address is a website such as an email website that requires a login, login authentication information such as a user identifier and a password that are used to logon to the website and web access-related information are registered under control of the control unit 170 (S215).

The web access-related information may include information indicating which part of a webpage provided by the website corresponding to the received website address is to be displayed on a screen of the display unit 140 when the website is accessed for the first time. The control unit 170 may also encrypt the login authentication information and store the encrypted login authentication information in the memory unit 130. Further, when the mobile communication device 100 includes a subscriber authentication module, the control unit 170 preferably stores the login authentication information in the subscriber authentication module.

Next, alarm-related information is registered under control of the control unit 170 (S220). The alarm-related information may include recurrent alarm information indicating whether to output an alarm signal everyday from Monday to Friday, from Monday to Saturday, from Monday to Sunday, etc. Also, the alarm-related information may include alarm frequency information indicating whether to output an alarm signal once, twice, three times, four times, etc. and alarm interval information indicating whether to output an alarm signal at intervals of five, ten, or thirty minutes, for example. Also, the alarm-related information may include information indicating whether to output a ring sound, a vibration signal, a light flashing, a personal voice message, a music file, etc, as an alarm signal.

Then, in step S225, the control unit 170 determines whether or not the user wants to change any of the information registered in the steps S210 through S220. When the control unit 170 determines the user does not want to change any of the registered information, the setting of the web alarm function is completed.

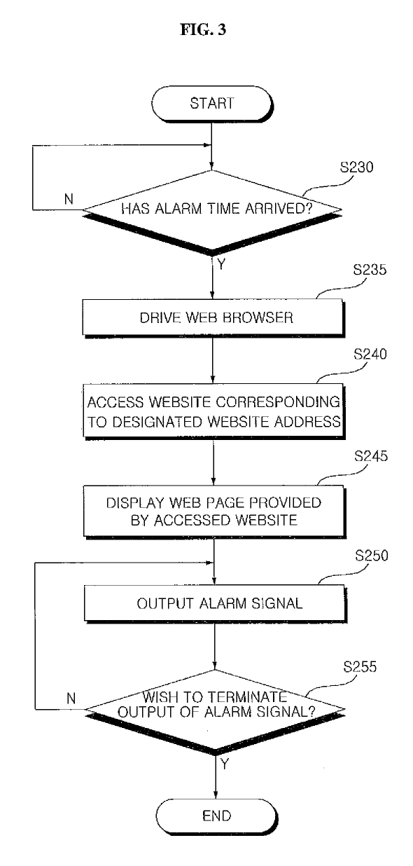

Turning now to FIG. 3, which is flowchart illustrating a method of displaying a webpage of a corresponding website upon arrival of a designated alarm time according to an embodiment of the present invention. As shown in FIG. 3, the control unit 170 determines if an alarm time previously set by the user has arrived (S230). When the control unit 170 determines the alarm time has arrived (Yes in S230), the control unit 170 drives a web browser upon the arrival of the alarm time (S235).

Next, the control unit 170 accesses, via the wireless communication unit 110, a website corresponding to a previously registered website address (S240). Further, as discussed above, the control unit 170 can recognize the arrival of the alarm time using a timer (not shown) included therein. Then, in step S245, the control unit 170 controls a web page provided by the accessed website to be displayed on a screen of the display unit 140. Further, as discussed above, the user may set which part of the web page provided by the website is to be displayed on the screen of the display unit 140.

Next, the control unit 170 outputs an alarm signal to according to registered alarm-related information (S250). Further, the control unit 170 may output the alarm for a predetermined amount of time, until particular conditions are met (e.g., a touch screen on the mobile device is touched), or based on other user operations (e.g., the user setting the predetermined amount of time).

Now turning to FIG. 4, which is flowchart illustrating a method of displaying a webpage of a corresponding website upon arrival of a designated alarm time according to another embodiment of the present invention. As shown in FIG. 4, the control unit 170 first determines if a previously set alarm time has arrived (S260) and drives a web browser upon the arrival of the alarm time. Further, in the step S270, the control unit 170 controls the wireless communication unit 110 to access a website corresponding to a website address registered using a web alarm setting menu.

Then, the control unit 170 logs onto the accessed website by inputting one or more items used to log onto the accessed website with reference to registered login authentication information and then selects a ‘login’ button, for example, displayed on the accessed website (S280). Next, the control unit 170 controls a designated web page of the accessed website to be displayed (S285). For example, if the accessed website is an email website, the designated web page of the accessed website may be a web page including a list of received emails.

In addition, the control unit 170 then outputs an alarm signal according to registered alarm-related information (S290). The output of the alarm signal may continue until the user decides to terminate the output of the alarm signal or a predetermined condition is met. That is, in step S295, the control unit 170 determines when to stop outputting the alarm signal. Therefore, in this embodiment, it is possible to set a web alarm for a website that requires a login. Also, it is possible for a user to check out stock prices on a regular basis by being automatically directed to a web page provided by a securities company's website at regular time intervals.

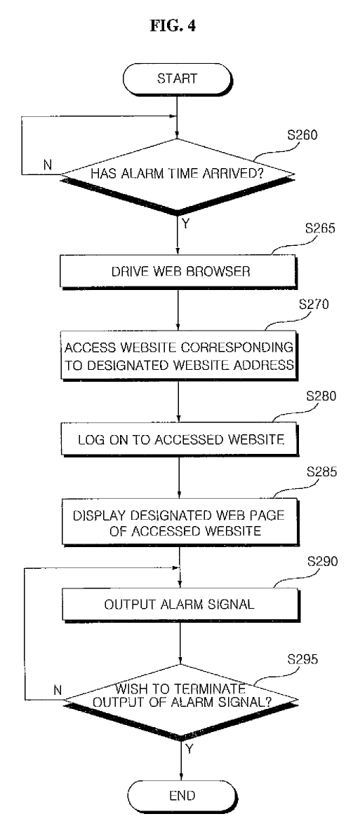

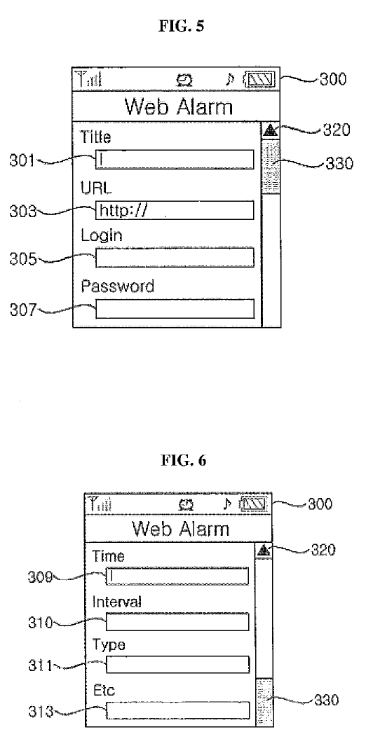

Turning next to FIGS. 5 and 6, which are overviews illustrating a web alarm setting menu screen according to embodiments of the present invention. As shown in FIG. 5, a web alarm setting menu screen 300 includes an item ‘Title’ 301 for inputting the title of a website, an item ‘URL’ 303 for inputting a website address corresponding to a desired website, an item ‘Login’ 305 for inputting a user identifier, and an item ‘Password’ 307 for inputting a password. A vertical scroll bar including a slider 330 and a scroll arrow 320 is also disposed on the right side of the web alarm setting menu 330 so that the web alarm setting menu screen 300 can be scrolled up and down. Thus, the user can easily enter information corresponding to the website he or she wants to be displayed at a particular alarm time.

Further, FIG. 6 illustrates the web alarm setting menu screen 300 being scrolled downwards from the state in FIG. 5 and also including an item ‘Time’ 309 for setting an alarm time, an item ‘Interval’ 310 for setting an alarm interval, an item ‘Type’ 311 for choosing one of various types of alarm signals such as a ring sound, vibration mode, flashing light mode, a music file, a prerecorded user's voice, etc., and an item ‘Etc’ 313 for registering other web access-related information. However, the web alarm setting menu screen 300 does not need include all the items 301, 303, 305, 307, 309, 310, 311 and 313. In addition, the web alarm setting menu screen 300 can also include other items related to the webpage and alarm time.

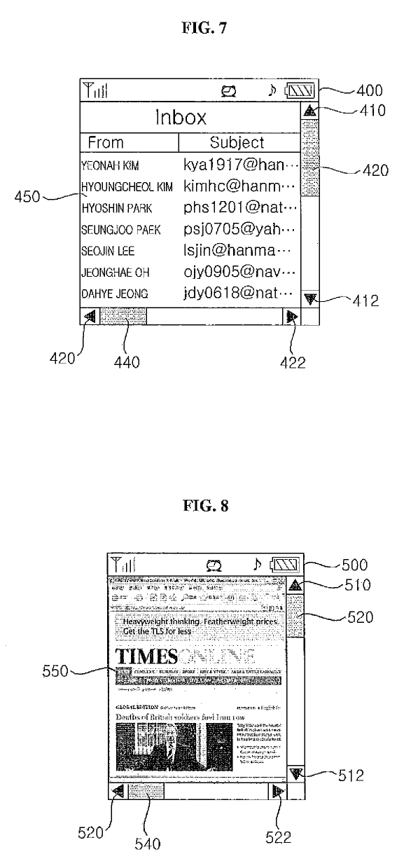

In addition, FIGS. 7 and 8 are overviews illustrating screen images displayed by a display unit upon the arrival of a designated alarm time according to embodiments of the present invention. More specifically, FIG. 7 illustrates an inbox screen 400 displayed upon accessing and logging onto an email website upon the arrival of the alarm time. Referring to FIG. 7, a part 450 of a web page provided by the email website is displayed on the inbox screen 400. A vertical scroll bar including a slider 420 and scroll arrows 410 and 412 is also disposed on the right side of the inbox screen 400, and a horizontal scroll bar including a slider 440 and scroll arrows 420 and 422 is disposed on the lower side of the inbox screen 400.

Further, FIG. 8 is an overview illustrating a news screen 500 displayed upon accessing an Internet news website. Referring to FIG. 8, a part 550 of a web page provided by the Internet news website is displayed on the news screen 500. A vertical scroll bar including a slider 520 and scroll arrows 510 and 512 is also disposed on the right side of the Internet news screen 500, and a horizontal scroll bar including a slider 540 and scroll arrows 520 and 522 is disposed on the lower side of the Internet news screen 500.

Thus, according to embodiments of the present invention, a website designated by a user is accessed at a preset alarm time, and then an alarm signal is output to the user. Therefore, it is possible to display a web page provided by a website to a user without at a preset alarm time requiring additional manipulation for accessing the website.

The present invention can be realized as computer-readable code written on a computer-readable recording medium that can be read by processors such as Mobile Station Modem (MSM) chips. Examples of the computer-readable recording medium include a ROM, a RAM, a flash memory, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner.

As described above, according to embodiments of the present invention, it is possible to access a designated website and output an alarm signal upon the arrival of a designated alarm time. Therefore, it is possible to maximize the user's convenience by accessing a designated website upon the arrival of a designated alarm time so that a user can be automatically provided with a web page of the designated website together with an alarm signal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of operating a mobile communication device, the method comprising:
receiving a website address;
receiving an alarm time;
accessing a website corresponding to the website address upon arrival of the alarm time; and
outputting an alarm signal in combination with accessing the website.

2. The method of claim 1, wherein the accessing step displays a web page provided by the accessed website.

3. The method of claim 1, further comprising:
receiving login authentication information necessary to log onto the accessed website; and
logging onto the accessed website using the login authentication information.

4. The method of claim 3, wherein the login authentication information includes a user identifier and a password.

5. The method of claim 3, further comprising:
encrypting the login authentication information; and
storing the encrypted login authentication information.

6. The method of claim 1, further comprising:
receiving an alarm time interval,
wherein the outputting step outputs the alarm signal in accordance with the alarm time interval.

7. The method of claim 1, wherein the accessing step displays a list of emails when the accessed website is an email website.

8. The method of claim 1, wherein the accessing step displays at least one stock value when the accessed website is a stock website.

9. The method of claim 1, wherein the alarm signal comprises at least one of a ring sound, a vibration signal, a light flashing signal, a music file, and a prerecorded user's voice.

10. The method of claim 1, further comprising:
providing a menu for inputting the website address and the alarm time, said menu including at least one of an address of the website, an alarm time, a login name for logging onto the website, and a password for logging onto the website.

11. A mobile communication device, comprising:
a wireless communication device configured to access the Internet;
a display unit configured to display a menu including fields allowing a user of the mobile communication device to input a website address and an alarm time; and
a control unit configured to receive the input website address and the alarm time, to access a website corresponding to the website address via the wireless communication device upon arrival of the alarm time, and to output an alarm signal in combination with accessing the website.

12. The mobile communication device of claim 11, wherein the control unit controls the display unit to display a web page provided by the accessed website.

13. The mobile communication device of claim 11, wherein the menu further includes fields allowing the user to input login authentication information necessary to log onto the accessed website, and
wherein the control unit logs onto the accessed website using the login authentication information.

14. The mobile communication device of claim 13, wherein the fields in the menu for the login authentication information includes a user identifier and a password.

15. The mobile communication device of claim 13, wherein the control unit encrypts the login authentication information, and stores the encrypted login authentication information in a memory of the mobile communication device.

16. The mobile communication device of claim 11, wherein the menu further includes a field allowing the user to input an alarm time interval, and
wherein the control unit outputs the alarm signal in accordance with the alarm time interval.

17. The mobile communication device of claim 11, wherein the control unit controls the display unit to display a list of emails when the accessed website is an email website.

18. The mobile communication device of claim 11, wherein the control unit controls the display unit to display at least one stock value when the accessed website is a stock website.

19. The mobile communication device of claim 11, wherein the alarm signal comprises at least one of a ring sound, a vibration signal, a light flashing signal, a music file, and a prerecorded user's voice.
